(19) United States
(12) Patent Application Publication
(10) Pub. No.: US 2002/0143923 A1
(43) Pub. Date: Oct. 3, 2002

(54) System and method for managing a device network

(75) Inventor: Bruce Alexander, Poulsbo, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Vigilos, Inc.

(21) Appl. No.: 10/117,557

(22) Filed: Apr. 3, 2002

Related U.S. Application Data
(60) Provisional application No. 60/281,254, filed on Apr. 3, 2001.

(51) Int. Cl. G06F 15/173

(52) U.S. Cl. 709/223

(57) ABSTRACT

A system and method for managing a distributed data processing network are provided. A distributed network environment is configured such that monitoring and control devices are associated with device servers in a secure subnet. Each device server connects with a premises server. According to the present invention, a client computing device utilizing a WWW browser employs a communication protocol to pass commands to device servers and devices through the premises server. In another aspect of the present invention, a distributed computing environment allows multiple device servers to cumulatively process data collected from cameras, sensors, and other attached devices and provide a common computing platform and user interface.

### CROSS-REFERENCE TO RELATED APPLICATION

This application claims the benefit of U.S. Provisional Application No. 60/281,254, entitled SYSTEM AND METHOD FOR MANAGING A DEVICE NETWORK and filed on Apr. 3, 2001. U.S. Provisional Application No. 60/281,254 is incorporated by reference herein.

### FIELD OF THE INVENTION

In general, the present invention relates to computer software, computer hardware, and communications networks, and in particular, to a system and method for the management of monitoring and control devices through a device network.

### BACKGROUND OF THE INVENTION

A facility, or group of facilities, may include a wide variety of monitoring devices and control devices (including input and output devices) to perform various security, environmental, and access control functions. Each networked device is typically configured separately and implemented in a manner such that most of the networked devices function independently of one another. In a conventional embodiment, facility control systems for security, environmental, and access control functions are typically administered through hardware control panels wired to the individual control devices within a monitored building.

Generally described, each individual control system has a low data management capacity and little, if any, interoperability with other control systems. For example, card and keypad readers are often utilized to provide ingress and egress controls. As a general rule, however, the typical intrusion and access devices and their respective control systems are not designed to store, process or transmit data acquired during operation. These systems alone cannot provide additional data storage and transmittal functionality that are important to monitor and track the facility. Accordingly, the conventional hard wired embodiment becomes deficient in that there is limited amount of data processing capacity and operability for the monitoring and control devices within a given system.

One attempt to relieve the memory constraints of individual controls is to couple them to a communications controller with a communications connection, such as an Ethernet connection, to a database server. In such an embodiment, information generated by networked devices may be shared across a wide-area network (“WAN”) to a number of authorized receivers such as mobile clients or fixed station clients. Although the conventional networked device approach provides some data outlet capabilities, this approach becomes deficient in situations where a facility with multiple devices, such as multiple video cameras, demands a large amount of bandwidth to transmit data on a frequent basis. One skilled in the relevant art will appreciate that monitoring devices, particularly video capture devices, produce a heavy stream of data. Accordingly, the network bandwidth resources are generally strained to support larger incoming data streams.

In addition to straining network commercial resources, the utilization of a number of video capture devices also places a strain on the computing device's processing resources. Generally described, a device server obtains raw video data from a video capture device and processes the data for analysis and/or transmission to other components. Processing the video image can include decompressing, watermarking, time-stamping, interpolation, and the like. The ability for a particular device server to handle multiple video capture devices depends primarily on the processing capability of the device server's central processing unit (“CPU”). Accordingly, a network having multiple networked video capture devices may need to allocate processing capabilities such that each video capture device is serviced by a separate device server. Thus, this approach is deficient in increasing the cost of maintaining the network.

In addition to the above mentioned deficiencies, the conventional network configuration, such as with an Internet Protocol (“IP”) addressable server linked to hardware devices within a facility, is also a potential security vulnerability. One skilled in the relevant art will understand that networked devices left exposed to an external network could be vulnerable to denial of service (“DoS”) and other forms of computer network intrusion or “hacking” that could affect the devices, the security of the data they collect, and ultimately, the security of the facility itself.

Thus, there is a need for a system and method for managing a network of monitoring and control devices.

### SUMMARY OF THE INVENTION

In accordance with the present invention, a system and method for managing a device network are provided. A distributed network environment is configured such that a plurality of monitoring and control devices are associated with one or more device servers in a secure subnet. Each device server connects with a premises server, such that the premises server serves as a gateway to external components, such as a central server or a client computing device. In one aspect of the present invention, a client computing device WWW browser interrupt signal communication protocol is utilized to pass data between the devices and the client computing device through the premises server. In another aspect of the present invention, a distributed computing environment allows multiple device servers to cumulatively process the monitoring device data.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of an Internet environment;

FIG. 2 is a block diagram illustrative of an integrated information system in accordance with the present invention;

FIG. 3 is a block diagram depicting an illustrative architecture for a premises server in accordance with the present invention;

FIG. 4 is a block diagram depicting an illustrative architecture for a device server in accordance with the present invention;

FIG. 5 is a block diagram depicting an illustrative architecture for a central server in accordance with the present invention;

FIG. 6 is a block diagram depicting an illustrative architecture for an authorized user computing device in accordance with the present invention;

FIG. 7 is a flow diagram illustrative of distributed networked environment communication routine in accordance with the present invention;

FIG. 8 is a flow diagram illustrative of an interrupt signal communication subroutine in accordance with the present invention;

FIG. 9 is a flow diagram illustrative of a monitoring device data processing routine in accordance with the present invention;

FIG. 10 is a flow diagram illustrative of a device event processing subroutine in accordance with the present invention; and

FIGS. 11A and 11B are flow diagrams illustrating an asset/resource event processing subroutine in accordance with the present invention.

### DETAILED DESCRIPTION OF THE PREFERRED EMBODIMENT

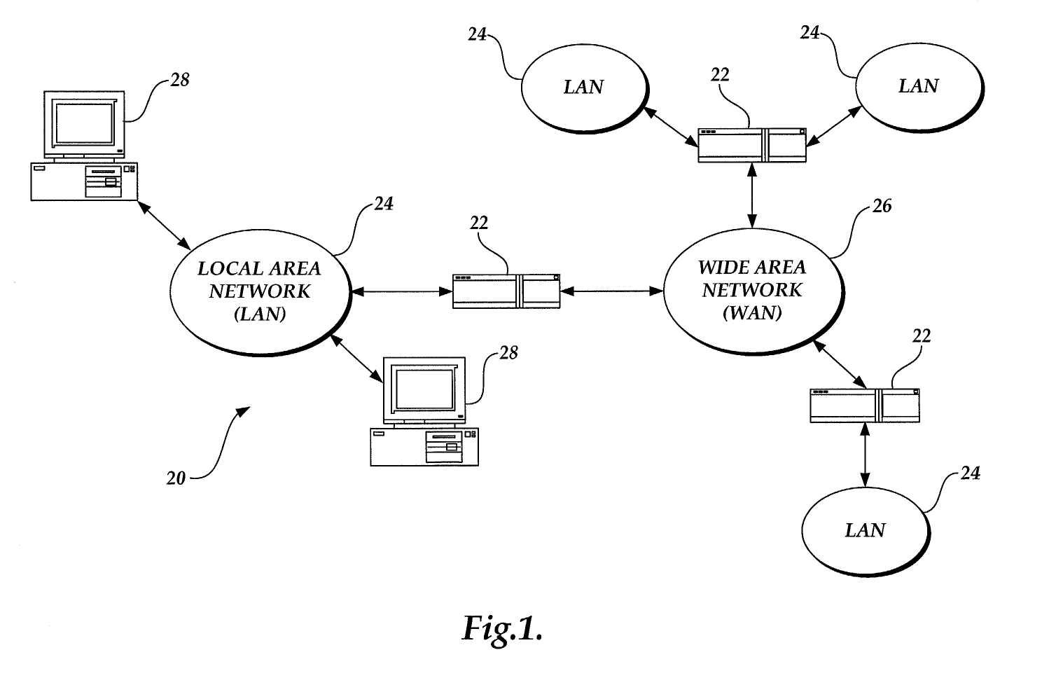

As described above, aspects of the present invention are embodied in a World Wide Web (the “WWW” or “Web”) site accessible via the Internet. As is well known to those skilled in the art, the term “Internet” refers to the collection of networks and routers that use the Transmission Control Protocol/Internet Protocol (“TCP/IP”) to communicate with one another. A representative section of the Internet 20 is shown in FIG. 1, in which a plurality of local area networks (“LANs”) 24 and a wide area network (“WAN”) 26 are interconnected by routers 22. The routers 22 are special purpose computers used to interface one LAN or WAN to another. Communication links within the LANs may be twisted wire pair, or coaxial cable, while communication links between networks may utilize 58 Kbps analog telephone lines, 1 Mbps digital T-1 lines, 45 Mbps T-3 lines or other communications links known to those skilled in the art. Furthermore, computers 28 and other related electronic devices can be remotely connected to either the LANs 24 or the WAN 26 via a modem and temporary telephone or wireless link. It will be appreciated that the Internet 20 comprises a vast number of such interconnected networks, computers, and routers and that only a small, representative section of the Internet 20 is shown in FIG. 1. One skilled in the relevant art will appreciate that aspects of the present invention may be practiced on Internet networks, such as an Intranet.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HyperText Markup Language (“HTML”), or other markup languages, that are electronically stored at “WWW sites” or “Web sites” throughout the Internet. A WWW site is a server connected to the Internet that has mass storage facilities for storing hypertext documents and that runs administrative software for handling requests for those stored hypertext documents. A hypertext document normally includes a number of hyperlinks, i.e., highlighted portions of text which link the document to another hypertext document possibly stored at a WWW site elsewhere on the Internet. Each hyperlink is associated with a Uniform Resource Locator (“URL”) that provides the exact location of the linked document on a server connected to the Internet and describes the document. Thus, whenever a hypertext document is retrieved from any WWW server, the document is considered to be retrieved from the WWW. As is known to those skilled in the art, a WWW server may also include facilities for storing and transmitting application programs, such as application programs written in the JAVA® programming language from Sun Microsystems, for execution on a remote computer. Likewise, a WWW server may also include facilities for executing scripts and other application programs on the WWW server itself.

A consumer or other remote consumer may retrieve hypertext documents from the WWW via a WWW browser application program. A WWW browser, such as Netscape's NAVIGATOR® or Microsoft's Internet Explorer, is a software application program for providing a graphical consumer interface to the WWW. Upon request from the consumer via the WWW browser, the WWW browser accesses and retrieves the desired hypertext document from the appropriate WWW server using the URL for the document and a protocol known as HyperText Transfer Protocol (“HTTP”). HTTP is a higher-level protocol than TCP/IP and is designed specifically for the requirements of the WWW. It is used on top of TCP/IP to transfer hypertext documents between servers and clients. The WWW browser may also retrieve application programs from the WWW server, such as JAVA applets, for execution on the client computer.

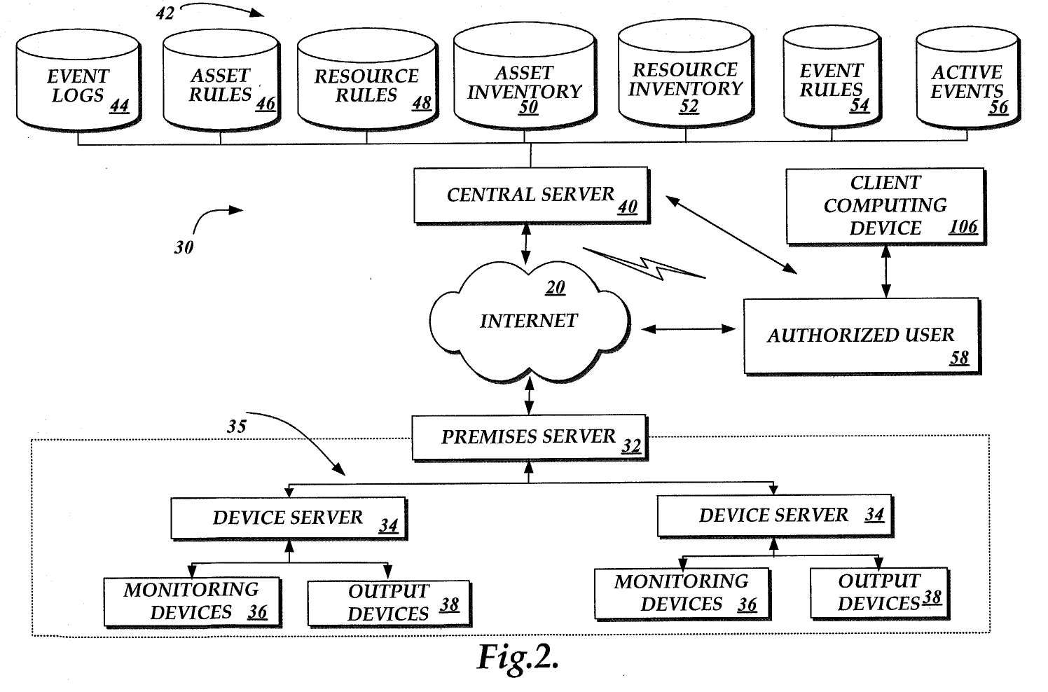

Referring now to FIG. 2, an actual embodiment of an integrated information system 30 in accordance with the present invention will be described. An integrated information system 30 is a subscriber-based system allowing a number of monitoring devices within one or more premises to be processed at a single control location. Additionally, the data from the monitoring devices is processed according to one or more rules. The control location customizes output of the processed data to a number of authorized users dependent on the preferences and rights of the user. While the system of the present invention is utilized to integrate traditional security monitoring functions, it is also utilized to integrate any information input in a like manner.

With reference to FIG. 2, the integrated information system 30 includes a premises server 32 that functions as a communication gateway between various monitoring devices 36 and control devices 38 and the integrated information system 30. The premises server 32 communicates with one or more device servers 34 via a communication network, such as a subnet, to address individual monitoring devices 34 and/or control devices 38. For example, the subnet may be a switched Ethernet network that runs through a high-speed switch. In an illustrative embodiment of the present invention, the device servers 34 are configured in a distributed network 35 that facilitates the sharing of computing resources, including processing, memory and communication bandwidth. The implementation of the distributed network will be explained in greater detail below.

In accordance with the present invention, the monitoring devices 36 can include smoke, fire and carbon monoxide detectors. The monitoring devices 36 can also include door and window access detectors, glass break detectors, motion detectors, audio detectors and/or infrared detectors. Still further, the monitoring devices 36 can include computer network monitors, voice identification devices, video cameras, still cameras, microphones and/or fingerprint, facial, retinal, or other biometric identification devices. Still further, the monitoring devices 36 can include conventional panic buttons, global positioning satellite (“GPS”) locators, other geographic locators, medical indicators, and vehicle information systems. The monitoring devices 36 can also be integrated with other existing information systems, such as inventory control systems, point-of-sale systems, accounting systems, environmental monitoring devices such as heat, ventilation and air conditioning (“HVAC”), or the like. It will be apparent to one skilled in the relevant art that additional or alternative monitoring devices 36 may be practiced with the present invention.

The device servers 34 also communicate with one or more control devices 38. In an illustrative embodiment, the control devices 38 can include audio speakers, display or other audio/visual displays. The control devices 38 may also include electrical or electro-mechanical mechanical devices that allow the system to perform actions. The control devices 38 can include computer system interfaces, telephone interfaces, wireless interfaces, door and window locking mechanisms, aerosol sprayers, and the like. As will be readily understood by one skilled in the art, the type of control device is associated primarily with the type of action the information system 30 produces. Accordingly, additional or alternative control devices 38 are considered to be within the scope of the present invention.

With continued reference to FIG. 2, the premises server 32 is in communication with a central server 40. Generally described, the central server 40 obtains various monitoring device data, processes the data and outputs the data to one or more authorized users. In an illustrative embodiment, the communication between the central server 40 and the premises server 32 is remote and two-way. One skilled in the relevant art will appreciate that the premises server 32 and the central server 40 may utilize secure sockets layer (“SSL”) or other secure shell security software/protocols to transfer data.

Also in communication with the central server 40 is a central database 42. In an illustrative embodiment, the central database 42 includes a variety of databases including an event logs database 44, an asset rules database 46, a resource rules database 48, an asset inventory database 50, a resource inventory database 52, an event rules database 54 and an active events database 56. The utilization of the individual databases within the central database 42 will be explained in greater detail below. As will be readily understood by one skilled in the relevant art, the central database 42 may be one or more databases, which may be remote from one another. Additionally, it will be further understood that one or more of the databases 76 may be maintained outside of the central server 40.

With continued reference to FIG. 2, the central server 40 also communicates with one or more authorized users 58. In an illustrative embodiment, the authorized users 58 include one or more authorized users. Each authorized user has a preference of notification means and rights to the raw and processed monitoring data. The authorized users include premises owners, security directors or administrators, on-site security guards, technicians, remote monitors (including certified and non-certified monitors), customer service representatives, emergency personnel and others. As will be readily understood by one skilled in the art, various user authorizations may be practiced with the present invention.

In an illustrative embodiment of the present invention, the central server 40 communicates with the authorized users 58 utilizing various communication devices and communication mediums. The devices include personal computers, hand-held computing devices, personal digital assistants, cellular or digital telephones, digital pagers, and the like. Moreover, the central server 40 may communicate with these devices via the Internet 20 utilizing electronic messaging or Web access, via wireless transmissions utilizing the wireless application protocol, short message services, audio transmission, and the like. As will be readily understood by one skilled in the art, the specific implementation of the communication mediums may require additional or alternative components to be practiced. All are considered to be within the scope of practicing the present invention.

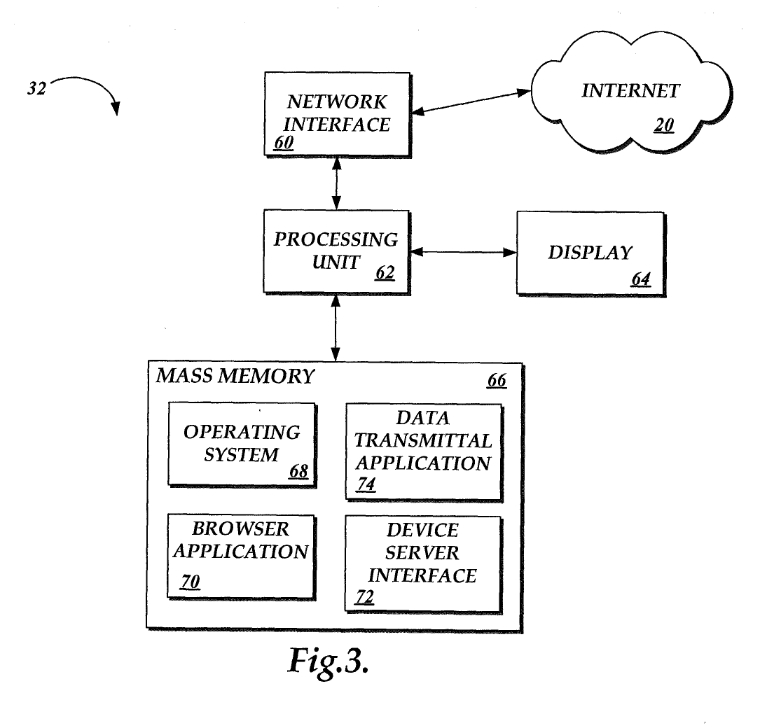

FIG. 3 is a block diagram depicting an illustrative architecture for a premises server 32. Those of ordinary skill in the art will appreciate that the premises server 32 include many more components than those shown in FIG. 3. However, it is not necessary that all of these generally conventional components be shown in order to disclose an illustrative embodiment for practicing the present invention. As shown in FIG. 3, the premises server 32 includes a network interface 60 for connecting directly to a LAN or a WAN, or for connecting remotely to a LAN or WAN. Those of ordinary skill in the art will appreciate that the network interface 60 includes the necessary circuitry for such a connection, and is also constructed for use with the TCP/IP protocol, the particular network configuration of the LAN or WAN it is connecting to, and a particular type of coupling medium. The premises server 32 may also be equipped with a modem for connecting to the Internet through a point-to-point protocol (“PPP”) connection or a serial line Internet protocol (“SLIP”) connection as known to those skilled in the art.

The premises server 32 each includes a processing unit 62, a display 64, and a mass memory 66, all connected via a communication bus, or other communication device. The mass memory 66 generally comprises a RAM, ROM, and a permanent mass storage device, such as a hard disk drive, tape drive, optical drive, floppy disk drive, or combination thereof. The mass memory 66 stores an operating system 68 for controlling the operation of the premises server 32. It will appreciated that this component may comprises a general-purpose server operating system as is known to those skilled in the art, such as UNIX, LINUX™, or Microsoft WINDOWS NT®. The memory also includes a WWW browser 70, such as Netscape's NAVIGATOR® or Microsoft's Internet Explorer browsers, for accessing the WWW.

The mass memory 50 also stores program code and data for interfacing with various device servers 34, for processing the monitoring device data and for transmitting the data to a central server 40. More specifically, the mass memory stores a device server interface application 72 in accordance with the present invention for communicating with the various device servers 34 to obtain monitoring device data. The device server interface application 72 comprises computer-executable instructions which, when executed by the premises server 32 obtains and transmits device data as will be explained below in greater detail. The mass memory 66 also stores a data transmittal application program 74 for transmitting the device data to a central server and to facilitate communication between the central server 40 and/or an authorized user 58 and the monitoring devices 36. The operation of the data transmittal application 74 will be described in greater detail below. It will be appreciated that these components may be stored on a computer-readable medium and loaded into the memory of the premises server 32 using a drive mechanism associated with the computer-readable medium, such as a floppy drive, CD-ROM drive, DVD-ROM drive, or network interface 60.

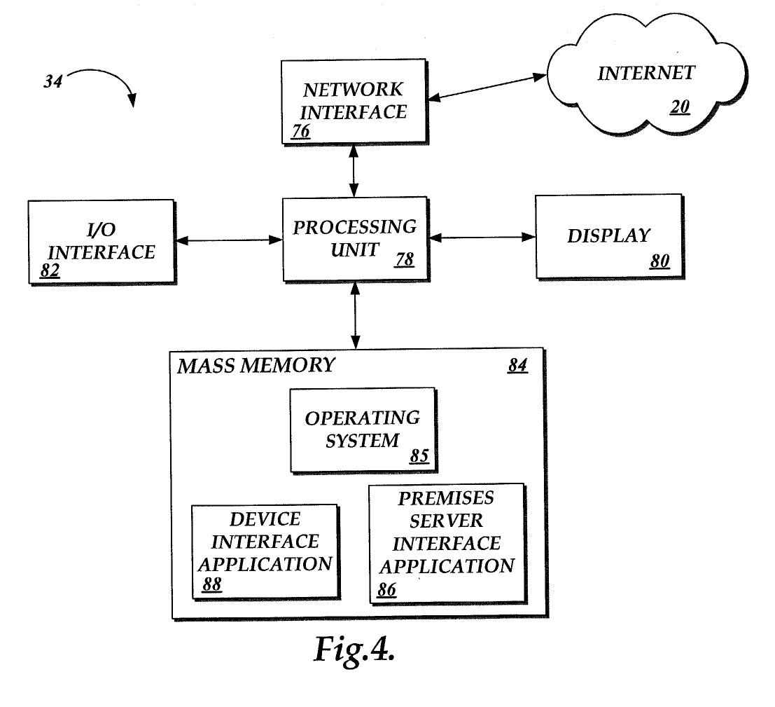

FIG. 4 is a block diagram depicting an illustrative architecture for a device server 34. Those of ordinary skill in the art will appreciate that the device server 34 includes many more components then those shown in FIG. 4. However, it is not necessary that all of these generally conventional components be shown in order to disclose an illustrative embodiment for practicing the present invention. As shown in FIG. 4, the device server 34 includes a network interface 76 for connecting directly to a LAN 24 or a WAN 26, or for connecting remotely to a LAN 24 or WAN 26. Those of ordinary skill in the art will appreciate that the network interface 76 includes the necessary circuitry for such a connection, and is also constructed for use with the TCP/IP protocol, the particular network configuration of the LAN or WAN it is connecting to, and a particular type of coupling medium. The device server 34 may also be equipped with a modem for connecting to the Internet through a PPP connection or a SLIP connection as known to those skilled in the art.

The device server 34 includes a processing unit 78, a display 80, an input/output (“I/O”) interface 82, and a mass memory 84, all connected via a communication bus, or other communication device. The I/O interface 82 includes hardware and software components that facilitates interaction with a variety of the monitoring devices via a variety of communication protocols including TCP/IP, X10, digital I/O, RS-232, RS-485 and the like. Additionally, the I/O interface 82 facilitates communication via a variety of communication mediums including telephone land lines, wireless networks (including cellular, digital and radio networks), cable networks and the like. One skilled in the relevant art will appreciate that individual devices connected by the I/O interface 82 to the device server 34 are identified by individual connection ports in the I/O interface 82.

The mass memory 84 generally comprises a RAM, ROM, and a permanent mass storage device, such as a hard disk drive, tape drive, optical drive, floppy disk drive, or combination thereof. The mass memory 84 stores an operating system 85 for controlling the operation of the device server 34. It will be appreciated that this component may comprise a general-purpose server operating system as is known to those skilled in the art, such as UNIX, LINUX™, or Microsoft WINDOWS NT®. The mass memory 84 also stores program code and data for interfacing with the premises server 32, other device servers 34, various monitoring devices 36 and control devices 38. More specifically, the mass memory 84 stores a server interface application 86 in accordance with the present invention for communicating with other device servers 34 and the premises server 32. The server interface application 86 comprises computer-executable instructions which, when executed by a device server 32 obtains and transmits device data as will be explained below in greater detail. The mass memory 84 also stores a device interface application 88 for communicating with the monitoring devices 36 and control devices 38 in conjunction with the I/O interface 82. The operation of the device interface application 88 will be described in greater detail below. It will be appreciated that the components may be stored on a computer-readable medium and loaded into the memory of the device server 34 using a drive mechanism associated with the computerreadable medium such as a floppy drive, CD-ROM drive, DVD-ROM drive, or network interface 76.

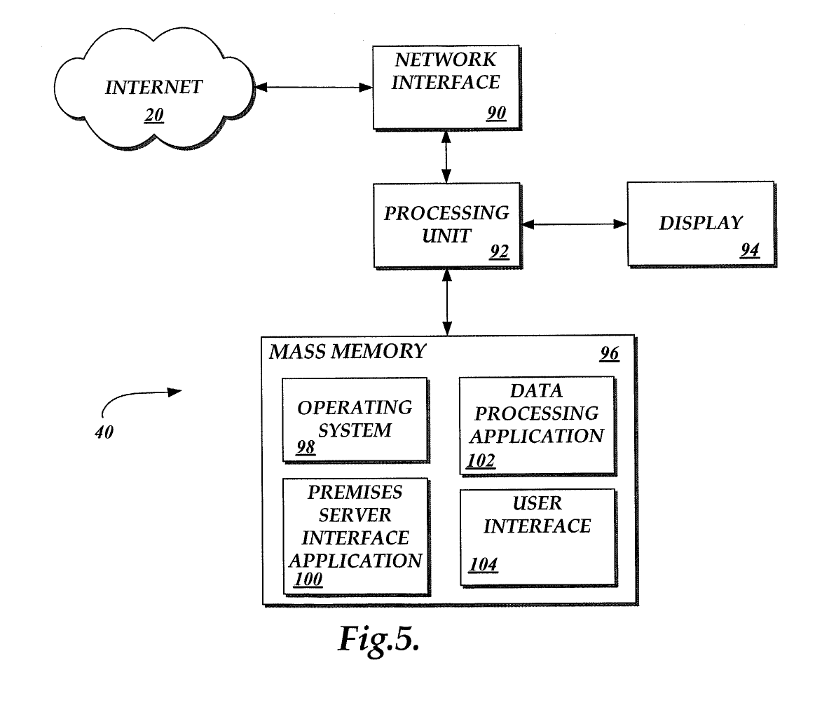

FIG. 5 is a block diagram depicting an illustrative architecture for a central server 40 in accordance with the present invention. Those of ordinary skill in the art will appreciate that the central server 40 includes many more components then those shown in FIG. 5. However, it is not necessary that all of these generally conventional components be shown in order to disclose an illustrative embodiment for practicing the present invention. As shown in FIG. 5, the central server 40 includes a network interface 90 for connecting directly to a LAN 24 or a WAN 26, or for connecting remotely to a LAN or WAN. Those of ordinary skill in the art will appreciate that the network interface 90 includes the necessary circuitry for such a connection, and is also constructed for use with the TCP/IP protocol, the particular network configuration of the LAN 24 or WAN 26 it is connecting to, and a particular type of coupling medium. The central server 40 may also be equipped with a modem for connecting to the Internet 20.

The central server 40 also includes a processing unit 92, a display 94 and a mass memory 96, all connected via a communication bus, or other communication device. The mass memory 96 generally comprises a RAM, ROM, and a permanent mass storage device, such as a hard disk drive, tape drive, optical drive, floppy disk drive, or combination thereof. The mass memory 96 stores an operating system 98 for controlling the operation of the central server 40. It will appreciated that this component may comprise a general-purpose server operating system as is known to those skilled in the art, such as UNIX, LINUX™, or Microsoft WINDOWS NT®.

The mass memory 96 also stores program code and data for interfacing with the premises server 32, for processing monitoring device data and for interfacing with various authorized users 58. More specifically, the mass memory 96 stores a premises server interface applications 100 in accordance with the present invention for communicating with the premises server 32. The premises interface application 100 comprises computer-executable instructions which, when executed by the central server 40, interfaces with the premises server 32 as will be explained below in greater detail. The mass memory 96 also stores a data processing application 102 for processing monitoring device data in accordance with rules maintained within the central database 42. The operation of the data processing application 102 will be described in greater detail below. The mass memory 96 further stores an authorized user interface application 104 for generating various graphical user interface to allow the authorized users 58 to communicate with the central server 40, the premises server 32, the device server 34, the monitoring devices 36 and the control devices 38. The operation of the authorized user interface application 104 will be described in greater detail below. It will be appreciated that these components may be stored on a computer-readable medium and loaded into the memory of the central server using a drive mechanism associated with the computer-readable medium, such as a floppy drive, CD-ROM drive, DVD-ROM drive, or network interface 76.

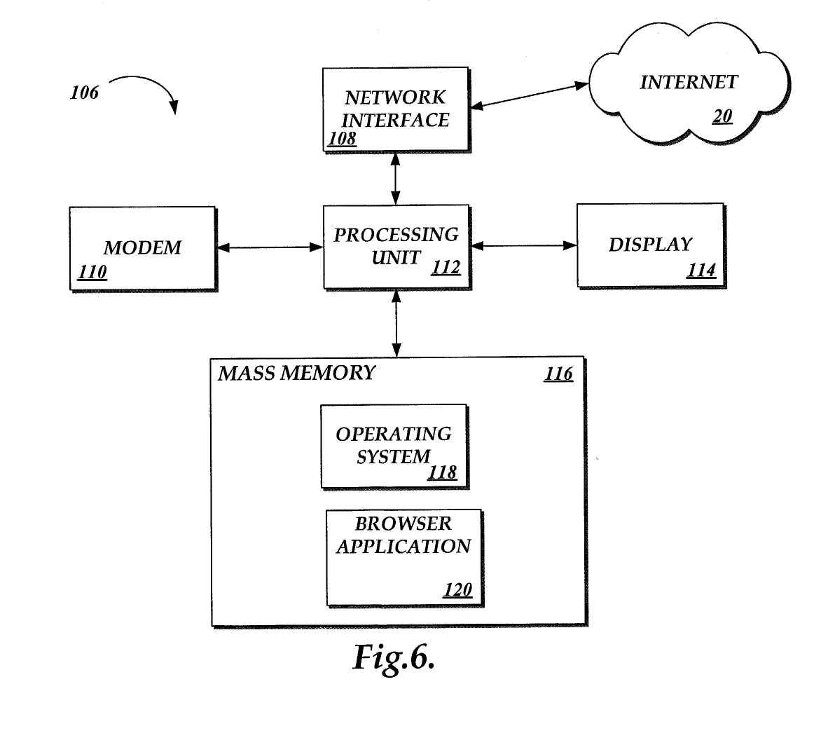

FIG. 6 is a block diagram depicting an illustrative architecture for a computing device 106 utilized by an authorized user 58 to present various graphical user interfaces in accordance with the present invention. Those of ordinary skill in the art will appreciate that the computing device 106 includes many more components then those shown in FIG. 6. However, it is not necessary that all of these generally conventional components be shown in order to disclose an illustrative embodiment for practicing the present invention. As shown in FIG. 6, the computing device 106 includes a network interface 108 for connecting directly to a LAN 24 or a WAN 26, or for connecting remotely to a LAN or WAN. Those of ordinary skill in the art will appreciate that the network interface 108 includes the necessary circuitry for such a connection, and is also constructed for use with the TCP/IP protocol, the particular network configuration of the LAN 24 or WAN 26 it is connecting to, and a particular type of coupling medium. The computing device 106 may also be equipped with a modem 110 for connecting to the Internet 20 through a PPP connection or a SLIP connection as known to those skilled in the art. Additionally, in an illustrative embodiment of the present invention, the client computing device 106 may be a mobile computing device and includes additional communication components for making a network connection.

The computing device 106 also includes a processing unit 112, a display 114, and a mass memory 116, all connected via a communication bus, or other communication device. The mass memory 116 generally comprises a RAM, ROM, and a permanent mass storage device, such as a hard disk drive, tape drive, optical drive, floppy disk drive, or combination thereof. The mass memory 116 stores an operating system 118 for controlling the operation of the computing device. It will appreciated that this component may comprise a general-purpose operating system as is known to those skilled in the art, such as UNIX, LINUX™, or Microsoft WINDOWS NT®. The memory 116 also includes a WWW browser 120, such as Netscape's NAVIGATOR® or Microsoft's Internet Explorer browsers, for accessing the WWW. In an actual embodiment of the present invention, the client computing device 106 interacts with the premises server 32 and the central server 40 via graphical user interfaces generated by the WWW browser application 120. Alternatively, the client computing device 106 may have one or more resident software application in mass memory for interfacing with the various components of the integrated information system 30.

Generally described, the present invention provides a distributed network environment for processing monitoring device 36 and control device 38 data. In an actual embodiment of the present invention, the distributed network environment 35 is utilized in conjunction with an integrated information system 30 to obtain monitoring device data and to initiate an output in the event the monitoring device data exceeds a defined threshold, the general function of which is described in detail below. One skilled in the relevant art will appreciate that the distributed network environment 35 of the present invention may be utilized in conjunction with other information or security systems and the disclosed embodiment is done solely for illustrative purposes. Another example of an information processing system may be found in commonly assigned U.S. Provisional Application No. 60/352,094 entitled SYSTEM AND METHOD FOR PREDICTIVE DATA ASSESSMENT IN A MONITORING NETWORK, and filed on Jan. 25, 2002, the disclosure of which is incorporated by reference. With reference to FIG. 2, the distributed network environment 35 includes at least one premises server 32 in communication with one or more device servers 34 via a public or private network. The premises server 32 functions as an external communication port between the monitoring devices 36 and control devices 38 and other components of the integrated information system 30. Accordingly, each device within the distributed network environment 35 is identified within the premises server 32 by a particular port number.

In accordance with the present invention, each device server 34 within the distributed network environment 35 is individually addressable by the premises server 32, such as with an IP address, and functions as the physical interface for the individual monitoring devices 36 and control devices 38. Generally, an individual device server 34 may communicate with one or more devices. Additionally, the device server 34 may be limited to connecting to a limited field of devices, such as particular kinds of devices (e.g., digital cameras) or communicating via particular protocols. Alternatively, the device server 34 may be capable with interfacing with a variety of devices and protocols.

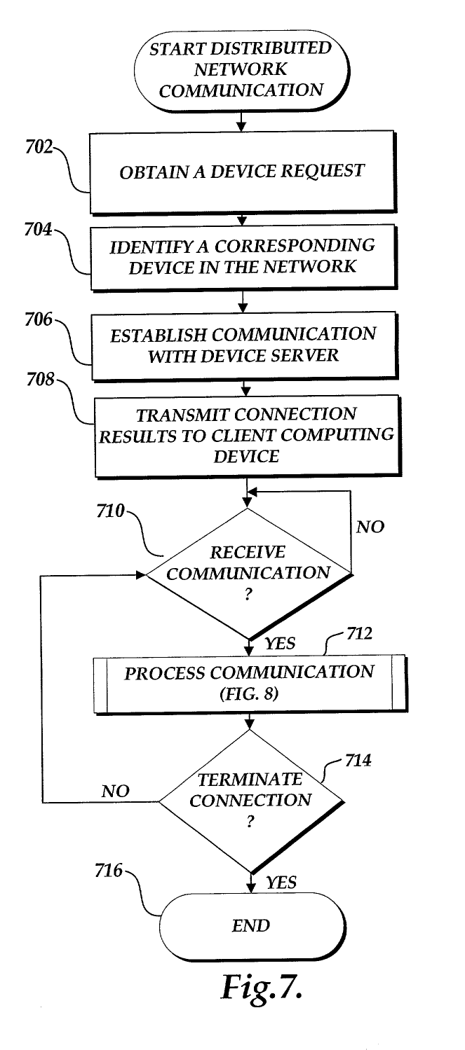

FIG. 7 is a flow diagram illustrative of a distributed network environment communication routine 700 in accordance with the present invention. At block 702, the premises server 32 obtains a request relating to a device. In an actual embodiment of the present invention, a browser application 120 on the authorized user computing device 106 transmits data to the premises server 32. The transfer of the data may be facilitated indirectly through the central server 40, or may be directly transferred to the premises server 32 through a communication medium such as the Internet 20. In accordance with this embodiment, the transmitted data specifies particular device parameters, such as a monitoring device 36 port, a device server IP address and a device-specific command set.

To facilitate the communication of data to individual devices, a set of device port identifiers, device server IP addresses and device-specific command sets are maintained within the integrated information system. For example, the central database 42 of the central server 40 maintains the information and transfers the information upon receipt of a request issued by the premises server 32. Alternatively, the premises server may maintain the data locally. In accordance with an actual embodiment of the present invention, the premises server 32 dynamically generates one or more control applets that run within an instance of the WWW browser 120 of the client computing device 106. The control applets include resources that allow the computing device 106, through the WWW browser 120, to issue the appropriate request to the premises server 32. The generation of the control applets is described in co-pending and commonly assigned U.S. patent application Ser. No. 09/966,815, filed on Sept. 28, 2001, entitled SYSTEM AND METHOD FOR DYNAMIC INTERACTION WITH REMOTE DEVICES to Alexander et al., which is hereby incorporated by reference.

At block 704, the premises server 32 uses the data in the transmission to identify the one or more devices being targeted. In an illustrative embodiment of the present invention, the device request includes an identification of the port numbers utilized by the premises server 32 to identify the specific device. At block 706, the premises server 32 forwards a command string to a corresponding device server 34. In an actual embodiment of the present invention, the premises server 32 may utilize an IP address specified in the communication from the client computing device 106 to identify the appropriate device server 34. For example, the first message sent by the client computer 106 can include a command string instructing the premises server 32 to connect to a particular device server 34. Alternatively, the premises server 32 may maintain a correlation chart to determine, or verify, a corresponding device server 34 for a specified device. Accordingly, the premises server 32 acts as an intermediary, or relay device, between a device and other components in the integrated information system 30, such as the central server 40 or an authorized user 58 utilizing a computing device 106.

At block 708, if the premises server 32 successfully connects with the specified device server 34, the premises server 32 passes a successful connection message to the control applet on the computing device 106 and closes the connection with the client computing device 106. Alternatively, if the premises server 34 cannot establish a communication with the specified device server 34, the premises server 32 returns an error message to the computing device 106.

At decision block 710, the premises server 32 enters a transfer loop in which it waits for the client computing device 106 or the device server 34 to send further commands. If no communication is received, the premises server 32 returns to decision block 710. Alternatively, if a communication is received, at block 712, the premises server 32 processes the communication. In an actual embodiment of the present invention, communication between the client computing device 106 and the premises server 32 can be accomplished utilizing an interrupt signal processing subroutine.

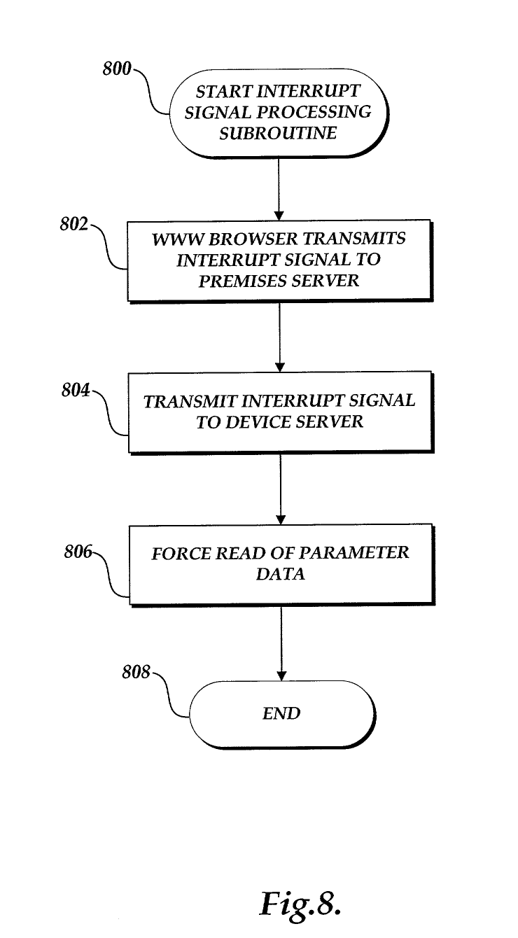

FIG. 8 is a flow diagram illustrative of an interrupt signal processing subroutine 800 utilized in accordance with the present invention. One skilled in the relevant art will appreciate that interrupt signals are operating system tools that are used to communicate state changes to signal-sensitive applications. Generally described, interrupt signals are used for handling critical or maintenance functions. In accordance with this aspect of the present invention, the native signal processing capabilities of the device server operating system 85 are utilized to force applications to perform maintenance functions in response to unrelated events. For example, a user can change database tables containing a default parameter for a software application running within the operating system 68. Accordingly, the device interface application 88 can change or replace a parameter for a specific device without requiring the device interface application 88 to check for new parameters.

At block 802, the WWW browser 120 of the client computing device 106 transmits an interrupt signal to the premises server 32 using a network connection, such as the Internet 20. One skilled in the relevant art will appreciate that current WWW browser applications, such as the WWW browser 120 of the client computing device 106 do not allow a browser-based remote user interface to issue an interrupt signal directly to the device server 34 controlling the specified device. Accordingly, the client computing device transmits the interrupt signal through the premises server 32. At block 804, the premises server 32 transmits the interrupt signal to the targeted device server 34.

At block 806, the device interface application 88 utilizes the operating system 85 interrupt handling process to force a re-read of the parameter data. In accordance with an actual embodiment of the present invention, when the interrupt occurs, the data passed to the operating system 85 interrupt handling function is limited to the interrupt signal to be processed. One skilled in the relevant art will understand that memory cannot be global to the device interface application 88 unless that memory is reserved specifically by the application 88 when it is initiated by the operating system 85. In order for the application process to be reentrant, the global memory must be at a location specific to each invocation of the device interface application 88. However, because the location of the memory allocated to the device interface application 88 is local to the main function of the application 88, which reserved and initialized the working storage area for the application, a location cannot be specified by the interrupt processing.

Accordingly, in an actual embodiment of the present invention, the current physical memory location for the invocation's working storage is stored in a semaphore file. The information stored in the semaphore file is specific to the operating system's 85 process identification number for the current invocation of the application. When an interrupt occurs, the interrupt handling process looks for the semaphore file and interprets the memory address stored in the file. After re-associating the application's working storage with this address, the operating system interrupt handling routine validates the data at that memory location by comparing the process identification number in the storage area (saved by the process when the memory was reserved) with the current process identification number. If the two match, the working storage is assumed to be relevant. The interrupt handling process is then free to perform system functions as required. At block 808, the interrupt processing subroutine terminates.

Returning to FIG. 7, at decision block 714, a test is performed to determine whether the communication should be terminated. In accordance with an illustrative embodiment of the present invention, when the client computing device 106 is ready to stop it will send a command to the premises server 32. If the command is received, the process 700 terminates at block 716. Alternatively, the process returns to decision block 710 to receive the next interrupt signal.

In accordance with another aspect of the present invention, the distributed network environment 35 also facilitates the sharing of computing resources between device servers 34. One skilled in the relevant art will understand that a distributed computing environment allows for device data processing to be performed by separate computers, such as multiple device servers 34, connected through a communication network. These computers may be closely co-located within a single sub-network; or they may be in geographically distant locations and on separate networks. As long as the computers are able to directly address one another through a networking protocol they can be incorporated into a single network environment.

In one distributed environment embodiment, processing requests may be distributed among device servers 34 according to load balancing methodologies. In accordance with this embodiment, a computing device, such as the premises server 32 or a master device server 34, manages the distribution of tasks among the device servers 34 according to their workload and processing capacity. In another distributed network environment embodiment, a device server 34 may distribute individual processing tasks to be completed by other device servers 34 in the distributed network environment 35.

In accordance with yet another aspect of the present invention, a device server 34 can monitor its own workload levels, and reassign one or more tasks to other device servers 34. In an illustrative embodiment of the present invention, workload levels can relate to the device server's resource utilization, such as CPU utilization, network utilization, and the like. The workload levels can also relate to the number of pending data processing requests. According to this embodiment, each device server 34 within the network will periodically record its current workload and processing capacity in a shared database. Distribution of tasks may then be based upon retrieving and analyzing information in the share database to determine the availability of each device server 34 in the network. In an alternative embodiment, each device server 34 in a network reports its workload and processing capacity to a master server which manages the distribution of tasks among the device servers 34 in the network.

In a further aspect of the present invention, a device server 34 may be connected to any number of monitoring devices 36 or control devices 38. Additionally, each monitoring device 36 or control device 38 may be connected to more than one device server 34. Thus, a device server 34 may utilize the distributed network environment to redistribute processing tasks in the event that the processing capacity of the assigned device server 34 is strained. One skilled in the relevant art will recognize that there are other, alternative ways, which task distribution and workload balancing may be performed among device servers in a distributed network that are not mentioned, but are contemplated as part of the present invention.

Having described the general operating and benefits of the distributed network environment 35, a general description of the integrated information system 30 for use with the distributed network environment will be explained. One skilled in the relevant art will appreciate that the distributed network environment 35 may be utilized in additional or alternative network configurations. Accordingly, the disclosed embodiments are provided solely for illustrative purposes and should not be considered limiting.

In an actual embodiment of the present invention, the monitoring device data is categorized as asset data, resource data or device data. Asset data is obtained from a monitoring device corresponding to an identifiable object that is not capable of independent action. For example, asset data includes data obtained from a bar code or transponder identifying a particular object, such as a computer, in a particular location. Resource data is obtained from a monitoring device corresponding to an identifiable object that is capable of independent action. For example, resource data includes data from a magnetic card reader that identifies a particular person who has entered the premises. Event data is obtained from a monitoring device corresponding to an on/off state that is not correlated to an identifiable object. Event data is a default category for all of the monitoring devices. As will be readily understood by one skilled in the relevant art, alternative data categorizations are considered to be within the scope of the present invention.

The monitoring device data is obtained by the monitoring devices 36 on the device server 34 and transmitted to the premises server 32, which then communicates with the central server 40. The central server 40 receives the monitoring device data and processes the data according to a rules-based decision support logic. In an actual embodiment of the present invention, the central server 40 maintains databases 42 having logic rules for asset data, resource data and event data. Moreover, because the monitoring device data is potentially applicable to more than one authorized user, multiple rules may be applied to the same monitoring device data. In an alternative embodiment, the databases 42 may be maintained in locations remote from the central server 40. One skilled in the art will recognize that the evaluation of device information collected from the monitoring devices 36 can be performed at any point and that the description given here is meant to depict one of several alternatives. For instance, rule evaluation can be performed at either the device server 34 or premises server 32 and notifications can be sent from each processing location.

In the event the processing of the monitoring device rules indicates that action is required, the central server 40 generates one or more outputs associated with the rules. The outputs include communication with authorized users 58 selected according to the monitoring device data rules. For example, an authorized user 58 may indicate a hierarchy of communication mediums (such as pager, mobile telephone, land-line telephone) that should be utilized in attempting to contact the user. The rules may also indicate contingency contacts in the event the authorized user cannot be contacted. Additionally, the rules may limit the type and/or amount of data the user is allowed to access. Furthermore, the outputs can include the initiation of actions by the central server 40 in response to the processing of the rules.

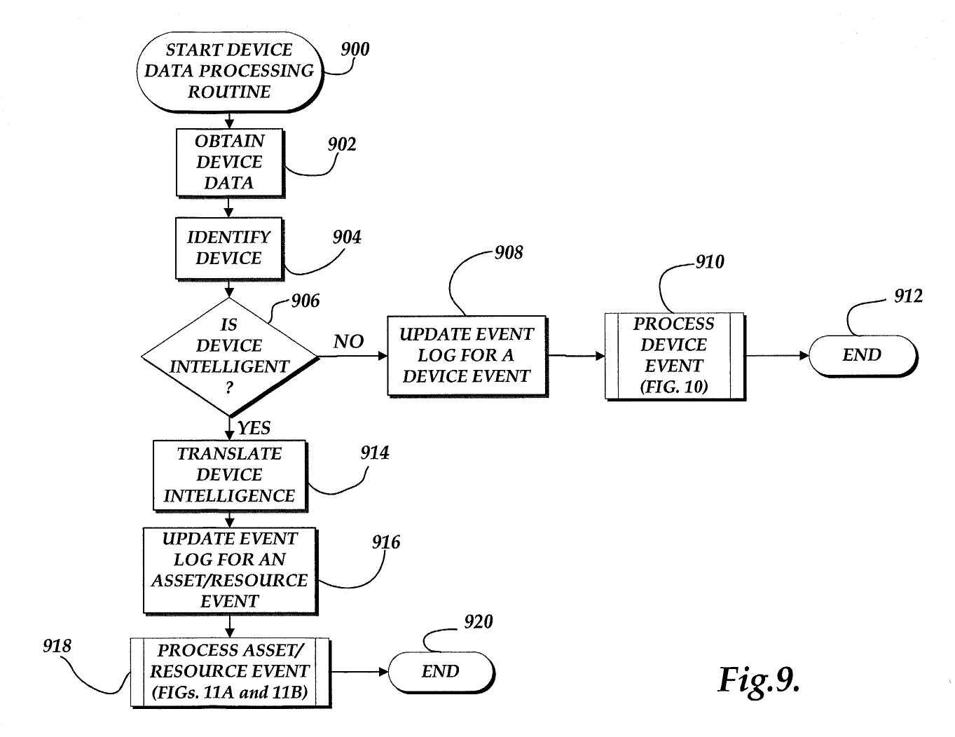

FIG. 9 is a flow diagram illustrative of a device decision support routine 900 for processing the monitoring device data in accordance with the present invention. At block 902, the central server 40 obtains an input from a monitoring device. In an actual embodiment of the present invention, the input is obtained by the device interface application 88 of the device server 34 and transmitted to the premises server 32. The data transmittal application 74 of the premises server 32 then transmits the data to the central server 40. Alternatively, the central server 40 may poll the premises server 32 to obtain monitoring device data from the device server 34. At block 904, the central server 40 identifies the device processing the data. The identification may be accomplished by determining a network address from which the input originated and which is assigned to the specific devices, or by reading other identification data that can be included with the data input.

At decision block 906, a test is performed to determine whether the device data includes intelligence data. In an actual embodiment of the present invention, intelligent data is characterized as asset data or resource data, because the data contains information identifying the object. On the other hand, data that does not contain any information identifying an object is not considered intelligent. If the device is not determined to be intelligent or if the device cannot identified, at block 908, an event log database 44 is updated to reflect the input data. At block 910, the central server 40 processes the data according to a process device event subroutine. The routine 900 terminates at block 912.

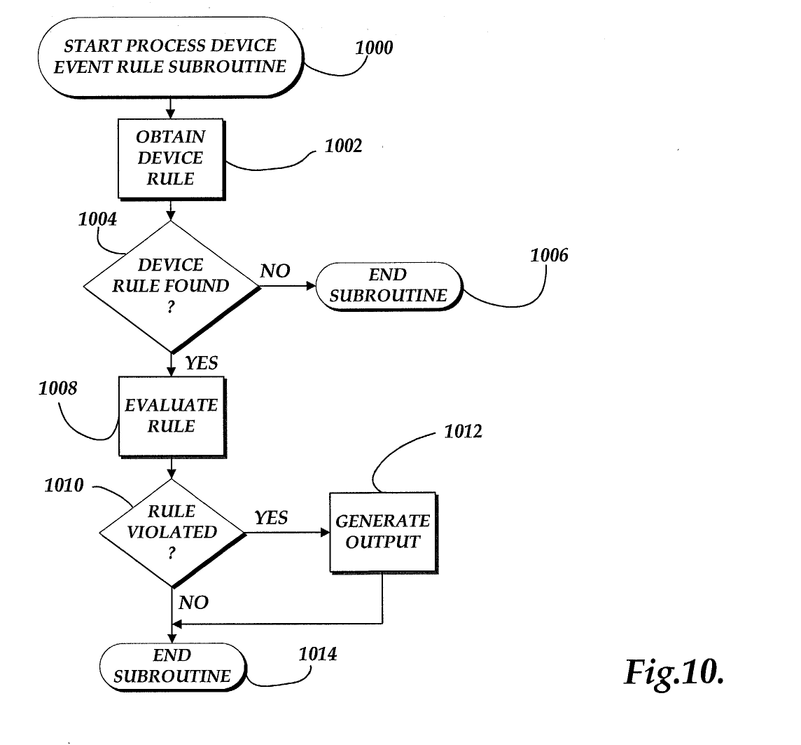

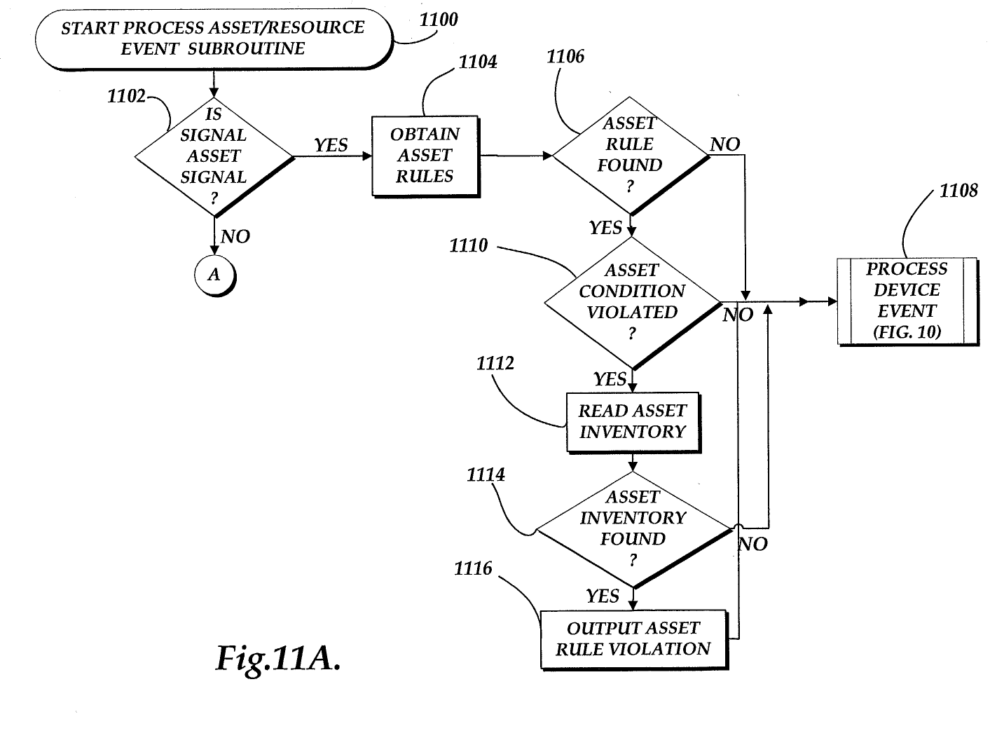

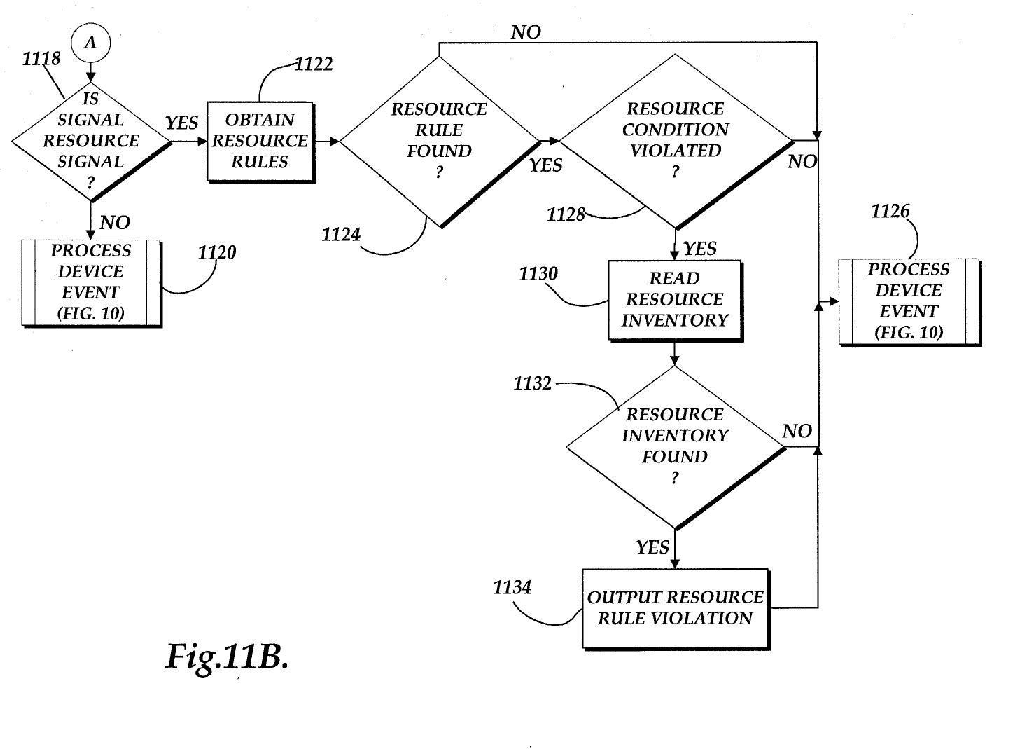

FIG. 10 is a flow diagram illustrative of a process device event subroutine 1000 in accordance with the present invention. At block 1002, the central server 40 obtains the monitoring device rules. In an actual embodiment, the monitoring device rules are stored in an event rules database 54 in communication with the central server 40. The rules contain data indicating one or more ranges for determining a rule violation. In a broad sense, a rule violation indicates that an event has occurred for which a notification is required. The ranges correspond to the type of data produced by the monitoring device. For example, if a monitoring device 36 is capable of only two stages (e.g., on or off), the rule may indicate that existence of one stage, e.g. “on”, is a violation. The rules may also include an indication that one or more monitoring device rules must also be considered before the rule is determined to be violated. For example, a rule corresponding to a glass break detector may indicate that a motion detector signal must be detected before the rule is violated. As will be readily understood by one skilled in the relevant art, additional or alternative rule types are considered to be within the scope of the present invention.

At decision block 1004, a test is performed to determine whether a device rule is found. If no rule is found, the process terminates at block 1006. If, however, a device rule is found, at block 1008, the central server 40 evaluates the rule according to the data received from the monitoring device 36. In an illustrative embodiment, the rules may include preset or default rules maintained by the central server 40. Additionally, the rules may include independently created rules by one or more authorized users. Moreover, one or more authorized users may be given the authority to modify or update rules via a user interface.

At decision block 1010, a test is performed to determine whether the device rule is violated. If the rule is violated, at block 1012, the central server 40 creates a rule violation output. In an actual embodiment of the present invention, the rules violation output instructions are included in the rule. The instructions include a list of the authorized users 58 to notify in the event of a rule violation and a hierarchy of which communication medium and devices should be utilized to contact each authorized user. For example, the rules may be in the form of logical if/then statements implementing an iterative hierarchy for establishing communication with an authorized user. Moreover, the instructions may also indicate the extent to which the authorized user has rights to the data. For example, the output may include the generation of a call to the premises owner's mobile device, the paging of an on-site monitor and a land-line telephone call to the public authorities. Alternatively, the central server may also maintain an output database indicating the output instructions corresponding to each rule.

In addition to generating communications, the rules violation output may also instigate an integrated system response. For example, in the case of an intrusion, a dye may be sprayed on the intruder from an aerosol sprayer. Additionally, the system may sound an audible alarm and directly dial emergency personnel. In an other example, if the system rules violations is a medical emergency, the central server 40 may call an ambulance, turn on lights within the premises, and unlock the doors to facilitate entry by the emergency personnel.

Once the central server 40 has generated the rules violation output at block 1012 or if the event rule is not violated at block 1010, the subroutine 1000 terminates at block 1014.

Returning to FIG. 9, if at block decision 906, the device data includes intelligence information, at block 914, the intelligence is translated from the monitoring device data. At block 916, the event logs database 44 is updated to reflect the input data. At block 918, the central server 40 processes the data according to a process asset/resource event subroutine. The routine 900 terminates at block 920.

FIGS. 11A and 11B are flow diagrams illustrative of a process asset or resource event subroutine 1100 in accordance with the present invention. With reference to FIG. 11A, at decision block 1102, a test is performed to determine whether the input signal is asset data. If the signal is identified as asset data, at block 1104, the asset rules are obtained. In an actual embodiment of the present invention, the asset rules are maintained and retrieved from an asset rules database 46. At block 1106, a test is performed to determine whether an asset rule is found. If no asset rule is found for the asset, the monitoring device data is processed as a device event at block 1108. In an actual application of the present invention, the device event is processed as described above with respect to the device event processing subroutine 1000 (FIG. 10). In an illustrative embodiment of the present application, in the event the asset rule processing cannot be completed, the monitoring device is still processed as a device-level event.

If an asset rule is found, at decision block 1110, a test is performed to determine whether the asset rule is violated. In an actual embodiment of the present invention, the asset rule contains data allowing the central server 40 to determine a rule violation. For example, an asset rule may contain information indicating a requirement of both a particular object (e.g., a computer) performing an action (e.g., logged into a network) for a violation. Additionally, the asset rule may indicate that additional device, resource or asset rules may be considered prior to determining whether the rule has been violated. As explained above, the rules may include preset rules maintained by the central server and user implemented/modified rules.

If the rule has not been violated, the monitoring device data is processed as a device event at block 1108. It will be generally understood by one skilled in the relevant art, that processing the rule as a both an asset and a device event allows for multiple purpose processing of the monitoring device data, such as the detection of a specific object and the detection of an object.

If the asset rule has been violated, at block 1112, the central server 40 reads a known asset inventory to identify the asset. In an actual embodiment of the present invention, the central server 40 maintains and reads from an asset inventory database 50. At decision block 1114, a test is performed to determine whether the asset is found in the asset inventory. If the asset is not found, the system defaults to processing the monitoring device data as a device event at block 1108. If the asset is found in the asset inventory, at block 1116, central server 40 outputs the asset violation. In an actual embodiment of the present invention, the asset rule contains instructions for generating output in the event of a rule violation to one or more authorized users. The instructions also contain a hierarchy of communication mediums and communication devices to attempt to contact the authorized user. Additionally, the instructions may contain alternative contact personnel if central server cannot contact the authorized user. Moreover, as explained above, the output may also instigate action by the integrated system. At block 1108, the monitoring device data is processed as a device event.

With reference to FIG. 11B, if the signal is not determined to be asset data at block 1102 (FIG. 11A), at decision block 1118, a test is done to determine whether the inputted signal is resource data. If the signal is not identified as resource data, at block 1120, the monitoring device data is processed as a device event. In an actual application of the present invention, the device event is processed as described above with respect to the device event processing subroutine 1000 (FIG. 10). If the signal is identified as resource data, at block 1122, the resource rules are obtained. In an actual embodiment of the present invention, the resource rules are maintained and retrieved from a resource Tules database 48. At block 1124, a test is performed to determine whether a resource rule is found. If no resource rule is found for the resource, the monitoring device data is processed as a device event at block 1126.

If a resource rule is found, at decision block 1128, a test is performed to determine whether the resource rule is violated. In an actual embodiment of the present invention, the resource rule contains data allowing the central server to determine a rule violation. Additionally, the resource rule may indicate that additional device, resource or asset rules may be considered prior to determining whether the rule has been violated. If the rule has not been violated, at block 1126, the monitoring device data is processed as a device event. It will be generally understood by one skilled in the relevant art, that processing the rule as a both a resource and a device event allows for multiple purpose processing of the monitoring device data.

If the resource rule has been violated, at block 1130, the central server 40 reads a known resource inventory to identify the resource. In an actual embodiment of the present invention, central server 40 maintains and reads from a resource inventory database 52. At decision block 1132, a test is performed to determine whether the resource is found in the resource inventory. If the resource is not found, the system defaults to processing the monitoring device data as a device event at block 1126. If the resource is found in the resource inventory, at block 1134, central server 40 outputs the resource violation. In an actual embodiment of the present invention, the resource rule contains instructions for generating output in the event of a rule violation to one or more authorized users. The instructions also contain a hierarchy of communication mediums and communication devices to attempt to contact the authorized user. Additionally, the instructions may contain alternative contact personnel if central server 40 cannot contact the authorized user 58. Moreover, as explained above, the output may also instigate action by the integrated system. At block 1126, the monitoring device data is processed as a device event (FIG. 10).

The present invention provides a network of hardware and software monitoring devices that manage facility data including environmental, security, and access control. The invention describes a network architecture that can be managed to collect data from an unlimited number of devices, while resolving bandwidth constraints as well as security concerns.

While illustrative embodiments of the invention have been illustrated and described, it will be appreciated that various changes can be made therein without departing from the spirit and scope of the invention.

The embodiments of the invention in which an exclusive property or privilege is claimed are defined as follows:

1. A data processing system for managing device-related data, the network comprising:
at least one device operable to generate device-related data;
at least one device server, the device server operable to obtain the device-related data from the at least one device; and
at least one premises server, the premises server operable to host communications between the at least one device server and an external component;
wherein the at least one device server is directly inaccessible by the external component.

2. The system of claim 1, wherein the premises server includes at least one communication port corresponding to a device server within the data processing network, and wherein the at least one communication port is operable to receive communications from an external component of the corresponding device server.

3. The system of claim 2, wherein the premises server is further operable to generate at least one control module capable of execution by an external component, wherein the at least one control module is operable to establish communications between the external component and a device server by communicating with a communication port on the premises server, the communication port corresponding to the device server.

4. The system of claim 1, wherein the premises server is further operable to obtain a communication request corresponding to at least one device server from the external component and forward a command string to the at least one device server.

5. The system of claim 4, wherein the communication request includes an identification of the device server.

6. The system of claim 5, wherein the identification of the device server is an Internet Protocol address.

7. The system of claim 5 further comprising a communication port database including communication port numbers corresponding to the at least one device, wherein the identification of the device server is a particular communication port number.

8. The system of claim 7, wherein the communication port database is maintained external to the premises server.

9. The system of claim 7, wherein the communication port database is maintained by the premises server.

10. The system of claim 4, wherein the device server is further operable to obtain the command string from the premises server and forward the command string to a corresponding device.

11. The system of claim 4, wherein the communication request is an interrupt request.

12. The system of claim 11, wherein the premises server is further operable to process the interrupt request via a semaphore file.

13. The system of claim 1, wherein the at least one device is a monitoring device.

14. The system of claim 1, wherein the at least one device is an control device.

15. The system of claim 1, wherein the data processing system includes two or more device servers operable to obtain the device-related data from the at least one device.

16. The system of claim 15, wherein the device servers are in a distributed computing environment.

17. A method for managing device-related data from one or more devices within a subnet on a premises server, the method comprising:
obtaining an access request for device-related data from an external component;
identifying a targeted device within the subnet;
establishing a connection between a premises server and the targeted device;
receiving device-related data from the targeted device; and
transmitting the device-related data to the external component.

18. The method of claim 17 further comprising transmitting the results of establishing the connection between the premises server and the targeted device to the external component.

19. The method of claim 17, wherein the access request for device-related data from an external component comprises device identification information.

20. The method of claim 19, wherein the device identification information comprises a communication port on the premises server associated with the device.

21. The method of claim 19, wherein the device identification information comprises an Internet Protocol address of the device in the subnet.

22. The method of claim 17, wherein obtaining an access request for device-related data includes obtaining an access request from a control module executed by the external component.

23. The method of claim 22 further comprising generating a control module operable to be executed by an external component, and transmitting the control module to the external component.

24. The method of claim 22, wherein the access request for device related data sent is an interrupt signal.

25. The method of claim 17, wherein identifying a targeted device within the subnet includes determining a network address in the subnet corresponding to a device specified in the access request.

26. The method of claim 25, wherein the network address is an Internet Protocol address.

27. The method of claim 17, wherein establishing a connection between the premises server and the targeted device includes transmitting command information to a device server connected to the targeted device, and the command information operable to cause the device server to read device-related data from the targeted device and transmit the device-related data to the premises server.

28. The method of claim 27, wherein transmitting command information includes transmitting an interrupt signal from the premises server to the device server.

29. The method of claim 17, wherein receiving device-related data from the targeted device includes obtaining an interrupt signal from the target device with the device-related data.

30. The method of claim 17, wherein transmitting the device-related data to the external component includes transmitting an interrupt signal to the external component with the device-related data.

31. The method of claim 17, wherein the device within the subnet is a monitoring device.

32. The method of claim 17, wherein the device within the subnet is an control device.

33. A computer-readable medium having computer-readable instructions capable of performing the method recited in any one of claims 17-32.

34. A data processing system for managing device-related data, the data processing system comprising:
one or more data generation means for generating device-related data;
one or more data collection means for collecting device-related data from the data generation means;
one or more data consumption means for consuming device-related data; and
one or more communication hosting means for hosting communications between the one or more data collection means and the one or more data consumption means;
wherein the one or more data collection means is directly inaccessible to the one or more data consumption means.

35. The data processing system of claim 34, wherein the communication hosting means includes a communication port means for receiving communications from a data consumption means specifying a port number corresponding to a particular data collection means.

36. The data processing system of claim 35, wherein the communication hosting means is also operable for:
generating one or more communication modules for use by the one or more data consumption means;
establishing communications between a data consumption means and a data collection means by communicating with the communication port means; and
specifying a communication port number corresponding to a the data collection means.

37. The data processing system of claim 34, wherein the communication hosting means is also operable for obtaining a communication request corresponding to the one or more data collection means from a data consumption means and forwarding a command string to a data collection means.

38. The data processing system of claim 37, wherein the communication request includes an identification of the data collection means.

39. The data processing system of claim 38, wherein the identification of the data collection means is an Internet Protocol address.

40. The data processing system of claim 38 further comprising a data storage means for correlating communication port numbers to the one or more data generation means, wherein each of the one or more data collection means is associated with a particular communication port number.

41. The data processing system of claim 40, wherein the data storage means is maintained external to the communication hosting means.

42. The data processing system of claim 40, wherein the data storage means is maintained by the communication hosting means.

43. The data processing system of claim 37, wherein the one or more data collection means is also operable for obtaining a command string from a communication hosting means and forwarding the command string to a data generation means.

44. The data processing system of claim 37, wherein the communication request is an interrupt request.

45. The data processing system of claim 44, wherein the communication hosting means is further operable for processing the interrupt request via a semaphore flag.

46. The data processing system of claim 34, wherein the one or more data generation means includes a monitoring device.

47. The data processing system of claim 34, wherein the one or more data generation means includes an output device.

48. The data processing system of claim 34, wherein the data processing system includes two or more data collection means for collecting device-related data from the one or more data generation means.

49. The data processing system of claim 48, wherein the data collection means are in a distributed computing environment.
